(19) United States
(12) Patent Application Publication
(10) Pub. No.: US 2025/0371263 A1
(43) Pub. Date: Dec. 4, 2025

(54) LARGE LANGUAGE MODEL PROMPT GENERATION AND STRUCTURING

(71) Applicant: Appian Corporation, McLean, VA (US)

(72) Inventors: Gabby Rothschild, Washington, DC (US); Tim Carroll, Washington, DC (US); Matt Flanagan, Arlington, VA (US); Rini Gupta, Herndon, VA (US)

(73) Assignee: Appian Corporation, McLean, VA (US)

(21) Appl. No.: 18/732,822

(22) Filed: Jun. 4, 2024

(51) Int. Cl. G06F 40/20; G06F 16/383

(52) U.S. Cl. CPC G06F 40/20; G06F 16/383

(57) ABSTRACT

Methods, systems, apparatuses, and non-transitory computer-readable media are provided for generating a prompt for a large language model. Operations may include receiving an input from a user, identifying an access level of the user, identifying a portion of a record associated with the input based on the access level of the user, identifying metadata associated with the portion of the record, identifying data associated with the portion of the record, generating the prompt based on a combination of the input, the data associated with the portion of the record, and the metadata associated with the portion of the record in a natural language format, and providing the prompt to the large language model.

### TECHNICAL FIELD

The present disclosure generally relates to systems, devices, methods, and computer-readable media for generating a prompt for a large language model.

### BACKGROUND

Organizations may store their data as records in various data sources. Records may organize large amounts of data through the use of complex relationships between many records or record types. Analyzing records may provide meaningful insights into the data stored in the records. However, because records may include large amounts of data in complex data structures, it can be difficult to generate meaningful insights into the records through manual analysis. To address this problem, large language models may be used to review, analyze, and summarize records. However, large language models may only allow for simple prompting and interaction through the use of a prompt and response. For example, large language models may allow for the use of generative artificial intelligence as a back-end running technology or may allow for chatbots to retrieve data or perform standard interactions. However, such uses of large language models may not be suitable for analyzing complex records, as a large language model may not understand the record relationships or the context for a given request. This lack of suitability and understanding makes the large language model more likely to misunderstand the request and produce incorrect or unhelpful responses. Additionally, such use of large language models may not take into account security considerations associated with the records, where users making requests regarding data records may only have access to some portion of the record or related records, creating a security risk for results being surfaced about data to which a user is not entitled to view. While typical large language model development has focused on providing ever more amounts of data to train large language models, this approach may exacerbate the above issues, in confusing a large language model as to the particular records and record relationships being inquired about, and creating further security risks regarding data provided to a large language model for training purposes.

Therefore, to address these technical deficiencies in analyzing complex records through large language models, technical solutions are needed to generate large language model prompts that may allow large language models to understand and interact with complex records. Such solutions should generate prompts that may allow a large language model to provide intelligible and accurate answers based on an understanding of how to interact with and analyze the complex, pre-existing data fabric associated with records. Such solutions should further ensure record-level security that may prevent the large language model from receiving data from records that the user does not have access to. Such record-level security may prevent a user who does not have access to certain data in the records from receiving answers from the large language model containing such secure data, and prevent the large language model from receiving more data than is necessary to address the particular request. Such solutions should generate a prompt that may allow a large language model to securely interact with complex records to provide overall trends, data comparisons, and other natural language queries of the records. These and other technical improvements are described below.

### SUMMARY

The disclosed embodiments describe non-transitory computer readable media for generating a prompt for a large language model. For example, in an embodiment, a non-transitory computer readable medium may include instructions that, when executed by at least one processor, cause the at least one processor to perform operations for generating a prompt for a large language model. The operations may comprise receiving an input from a user, identifying an access level of the user, identifying a portion of a record associated with the input based on the access level of the user, identifying data associated with the portion of the record, identifying metadata associated with the portion of the record, generating the prompt based on a combination of the input, the data associated with the portion of the record, and the metadata associated with the portion of the record in a natural language format, and providing the prompt to the large language model.

According to a disclosed embodiment, the operations may further comprise identifying at least one additional record related to the record, identifying, based on the access level of the user, data associated with a portion of the at least one additional record accessible to the user, identifying a relationship between the record and the at least one additional record, and generating the prompt based on a combination of at least two of: the input, the data associated with the portion of the at least one additional record, the data associated with the portion of the record, the relationship between the record and the at least one additional record, and the metadata associated with the portion of the record.

According to a disclosed embodiment, the record may include a plurality of identifiers, and the plurality of identifiers may identify a plurality of additional records.

According to a disclosed embodiment, the operations may further comprise identifying metadata associated with at least one additional record from the plurality of additional records accessible to the user based on the access level of the user, wherein the metadata may comprise a relationship between the record and the at least one additional record.

According to a disclosed embodiment, the operations may further comprise generating the prompt based on a combination of at least two of: the input, the metadata associated with the at least one additional record, the data associated with the portion of the record, and the metadata associated with the portion of the record.

According to a disclosed embodiment, the input may comprise at least one of: a request to summarize the record, a request about features of the record, or a request to generate an output based on the record.

According to a disclosed embodiment, the input may comprise at least one of: a pre-generated question or a user-generated question.

According to a disclosed embodiment, providing the prompt to the large language model may comprise transmitting the prompt through a proxy.

According to a disclosed embodiment, the proxy may provide authentication to the large language model.

According to a disclosed embodiment, the prompt may further comprise instructions for the large language model to interpret the record and the metadata.

According to a disclosed embodiment, the metadata associated with the record may comprise at least one of: a field-level display name, a field-level description, a record type display name, and a record type description.

According to a disclosed embodiment, the operations may further comprise receiving answer data from the large language model and transmitting the answer data to the user.

The disclosed embodiments further comprise a computer-implemented method for generating a prompt for a large language model. For example, in an embodiment, a computer-implemented method for generating a prompt for a large language model may include operations that may comprise receiving an input from a user, identifying an access level of the user, identifying a portion of a record associated with the input based on the access level of the user, identifying metadata associated with the portion of the record, identifying data associated with the portion of the record, generating the prompt based on a combination of the input, the data associated with the portion of the record, and the metadata associated with the portion of the record in a natural language format, and providing the prompt to the large language model.

According to a disclosed embodiment, the operations may further comprise receiving, from the large language model, answer data identifying at least one additional record related to the prompt, identifying data associated with a portion of the at least one additional record accessible to the user based on the access level of the user, generating a second prompt, wherein the second prompt includes the data associated with the portion of the at least one additional record, and providing the second prompt to the large language model.

According to a disclosed embodiment, the second prompt may further comprise metadata related to a context or a nature of a relationship between the record and the at least one additional record.

According to a disclosed embodiment, the record may comprise at least one of: a use case record, a customer record, or a support case record.

According to a disclosed embodiment, providing the prompt to the large language model may comprise transmitting the prompt through a proxy.

According to a disclosed embodiment, the proxy may comprise credentials for the large language model.

According to a disclosed embodiment, the metadata associated with the record may comprise at least one of: a field-level display name, a field-level description, a record type display name, and a record type description.

According to a disclosed embodiment, the operations may further comprise identifying data associated with a portion of at least one additional record related to the record based on the access level of the user and combining the data associated with the portion of the at least one additional record with the input, the data associated with the portion of the record, and the metadata associated with the portion of the record.

Aspects of the disclosed embodiments may include tangible computer readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, explain the disclosed embodiments.

FIG. 1 is a block diagram of a system for generating a prompt for a large language model, in accordance with disclosed embodiments.

FIG. 2 is a block diagram of a computing device including a prompt generation model for generating a prompt for a large language model, in accordance with disclosed embodiments.

FIG. 3 is a block diagram of a process for generating a prompt for a large language model, in accordance with disclosed embodiments.

FIG. 4 is a flowchart of a process for generating a prompt for a large language model, in accordance with disclosed embodiments.

### DETAILED DESCRIPTION

In the following detailed description, numerous specific details are set forth to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

The techniques for generating a prompt for a large language model described herein overcome several technological problems relating to the efficiency and functionality of large language models. In particular, the disclosed embodiments provide techniques for generating a prompt for a large language model to allow the large language model to understand and interact with complex records. As discussed above, large language models may be able to provide simple question and response interactions, which may not be suitable for analyzing large and complex records. Further, large language models may not be suitable for ensuring that secure data is not provided to users without access to such secure data.

The disclosed embodiments provide technical solutions to these and other problems arising from current techniques. For example, various disclosed embodiments create efficiencies over current techniques by providing a prompt generation model that can identify an access level of a user and further identify portions of a record that may be accessible to the user based on the access level of the user. The disclosed techniques may generate a prompt that may allow a large language model to understand and interact with only the user-accessible portions of the record. The disclosed techniques may reduce computational costs and increase computational efficiencies associated with receiving answer data from a large language model by reducing the size of the input transmitted to the large language model because the input transmitted to the large language model may only contain portions of the record that are accessible to the user rather than the entire record. Further, the disclosed techniques may ensure data security by only providing the large language model with data that is accessible to the user based on the access level of the user. Such disclosed techniques may ensure that the large language model does not receive sensitive data and a user does not receive sensitive data through an answer from a large language model.

Reference will now be made in detail to the disclosed embodiments, examples of which are illustrated in the accompanying drawings.

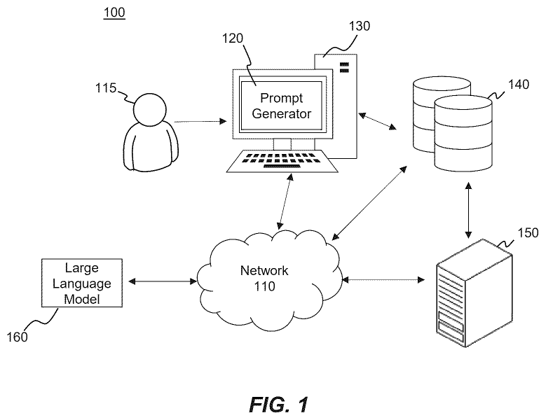

FIG. 1 depicts an exemplary system 100 for generating a prompt for at least one large language model, consistent with the disclosed embodiments. System 100 may represent an environment in which software code is developed and/or executed, for example in a cloud computing environment. System 100 may include one or more prompt generators 120, one or more computing devices 130, one or more databases 140, one or more servers 150, and one or more large language models 160, as shown in FIG. 1. User 115 may engage with system 100 through computing device 130.

The various components may communicate over a network 110. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system 100 is shown as a network-based environment, it is understood that the disclosed systems and methods may also be used in a localized system, with one or more of the components communicating directly with each other.

Computing devices 130 may be a variety of different types of computing devices capable of developing, storing, analyzing, and/or executing software code. For example, computing device 130 may be a personal computer (e.g., a desktop or laptop), an IoT device (e.g., sensor, smart home appliance, connected vehicle, etc.), a server, a mainframe, a vehicle-based or aircraft-based computer, a virtual machine (e.g., virtualized computer, container instance, etc.), or the like. Computing device 130 may be a handheld device (e.g., a mobile phone, a tablet, or a notebook), a wearable device (e.g., a smart watch, smart jewelry, an implantable device, a fitness tracker, smart clothing, a head-mounted display, etc.), an IoT device (e.g., smart home devices, industrial devices, etc.), or various other devices capable of processing and/or receiving data. Computing device 130 may operate using a Windows™ operating system, a terminal-based (e.g., Unix or Linux) operating system, a cloud-based operating system (e.g., through AWS™, Azure™, IBM Cloud™, etc.), or other types of non-terminal operating systems.

System 100 may further comprise one or more database(s) 140, for storing data. Database 140 may be accessed by computing device 130, server 150, or other components of system 100 for downloading, receiving, processing, editing, or running stored software or code. Database 140 may be any suitable combination of data storage devices, which may optionally include any type or combination of databases, load balancers, dummy servers, firewalls, back-up databases, and/or any other desired database components. For example, database 140 may include object databases, relational databases, graph databases, hierarchical databases, cloud databases, NoSQL databases, document databases, distributed databases, network databases, and/or any other suitable type of database. Additionally or alternatively, database 140 may use or be based on suitable types of data structures, such as trees, arrays, queues, linked lists, stacks, graphs, hash tables, and/or other types of data structures. In some embodiments, database 140 may be employed as a cloud service, such as a Software as a Service (SaaS) system, a Platform as a Service (PaaS), or Infrastructure as a Service (IaaS) system. For example, database 140 may be based on infrastructure or services of Amazon Web Services™ (AWS™), Microsoft Azure™, Google Cloud Platform™, Cisco Metapod™, Joyent™, vm Ware™, or other cloud computing providers. Data sharing platform 140 may include other commercial file sharing services, such as Dropbox™, Google Docs™, or iCloud™. In some embodiments, database 140 may be a remote storage location, such as a network drive or server in communication with network 110. In other embodiments database 140 may also be a local storage device, such as local memory of one or more computing devices (e.g., computing device 130) in a distributed computing environment.

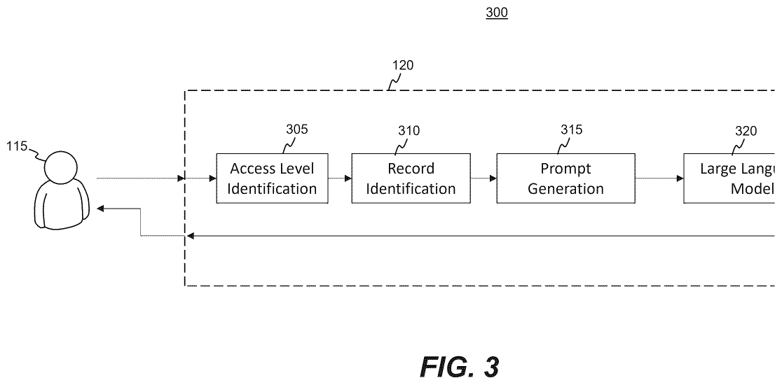

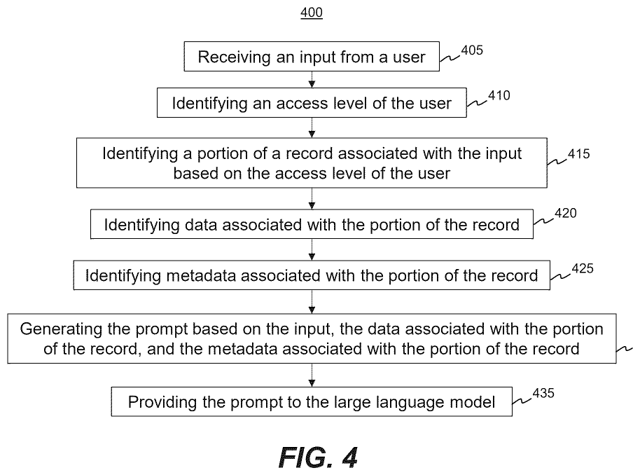

System 100 may also comprise one or more server device(s) 150 in communication with network 110. Server device 150 may manage the various components in system 100. In some embodiments, server device 150 may be configured to process and manage requests between computing devices 130 and/or databases 140. In embodiments where software code is developed within system 100, server device 150 may manage various stages of the development process, for example, by managing communications between computing devices 130 and databases 140 over network 110. Server device 150 may identify updates to code in database 140, may receive updates when new or revised code is entered in database 140, and may participate in generating a prompt for a large language model as discussed below in connection with FIGS. 3-4.

System 100 may also comprise one or more prompt generator 120 in communication with network 110. Prompt generator 120 may be any device, component, program, script, or the like, for generating a prompt for a large language model within system 100, as described in more detail below. Prompt generator 120 may be configured to monitor other components within system 100, including computing device 130, database 140, and server 150. In some embodiments, prompt generator 120 may be implemented as a separate component within system 100, capable of analyzing software and computer codes or scripts within network 110. In other embodiments, prompt generator 120 may be a program or script and may be executed by another component of system 100 (e.g., integrated into computing device 130, database 140, or server 150). Prompt generator 120 may further comprise one or more components (e.g., scripts, programs, etc.) for performing various operations of the disclosed embodiments. For example, prompt generator 120 may be configured to receive input from a user and identify an access level of the user. Examples of potential access levels are described in detail below. Prompt generator 120 may also be configured to identify a portion of a record associated with the input based on the access level of the user. Further, prompt generator 120 may be configured to identify data associated with the portion of the record and identify metadata associated with the portion of the record. In addition, as discussed below, prompt generator 120 may be configured to generate a prompt based on a combination of the input, the data associated with the portion of the record, and the metadata associated with the portion of the record in a natural language format. Prompt generator 120 may then provide the prompt to a large language model.

System 100 may further comprise at least one large language model 160. Large language model 160 may be any system, device, component, program, script, or the like, for receiving a prompt within system 100. For example, in some embodiments, large language model 160 may comprise a large language model such as Amazon Bedrock™, GPT™, LLaMA™, Gemini™, Claude™, or any other type of model or operation associated with a natural language. Large language model 160 may be in any desired form, such as a statistical model (e.g., a word n-gram language model, an exponential language model, or a skip-gram language model) or a neural model (e.g., a recurrent neural network-based language model or an LLM). In some examples, large language model 160 may include an LLM with artificial neural networks, transformers, and/or other desired machine learning architectures. In some embodiments, large language model 160 may include a trained language model. Large language model 160 may be trained using, for example, supervised learning, self-supervised learning, semi-supervised learning, unsupervised learning, and/or reinforcement learning. In some examples, large language model 160 may be pre-trained to generally understand a natural language, and the pre-trained language model may be fine-tuned for software development. For example, the pre-trained language model may be fine-tuned for software generation tasks based on training data of descriptions associated with software generation tasks, and the fine-tuned language model may be used to receive and process the identified software generation task. In some examples, large language model 160 may include generative pre-trained transformers (GPT) or other types of generative artificial intelligence configured to generate human-like content.

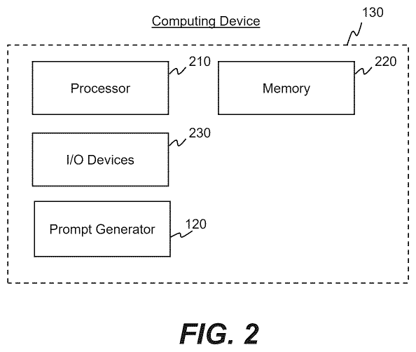

FIG. 2 is a block diagram showing a computing device 130 including prompt generator 120 in accordance with disclosed embodiments. Computing device 130 may include a processor (or processors) 210. Processor (or processors) 210 may include one or more data or software processing devices. For example, processor 210 may take the form of, but is not limited to, a microprocessor, embedded processor, or the like, or may be integrated in a system on a chip (SoC). Furthermore, according to some embodiments, processor 210 may be from the family of processors manufactured by Intel®, AMD®, Qualcomm®, Apple®, NVIDIA®, or the like. Processor 210 may also be based on the ARM architecture, a mobile processor, or a graphics processing unit, etc. In some embodiments, prompt generator 120 may be employed as a cloud service, such as a Software as a Service (SaaS) system, a Platform as a Service (PaaS), or Infrastructure as a Service (IaaS) system. For example, prompt generator 120 may be based on infrastructure of services of Amazon Web Services™ (AWS™), Microsoft Azure™, Google Cloud Platform™, Cisco Metapod™, Joyent™, vm Ware™, or other cloud computing providers. The disclosed embodiments are not limited to any type of processor configured in the computing device 130.

Memory (or memories) 220 may include one or more storage devices configured to store instructions or data used by the processor 210 to perform functions related to the disclosed embodiments. Memory 220 may be configured to store software instructions, such as programs, that perform one or more operations when executed by the processor 210 to generate a prompt for a large language model from computing device 130, for example, using process 400, described in detail below. The disclosed embodiments are not limited to software programs or devices configured to perform dedicated tasks. For example, the memory 220 may store a single program, such as a user-level application, that performs the functions of the disclosed embodiments, or may comprise multiple software programs. Additionally, the processor 210 may in some embodiments execute one or more programs (or portions thereof) remotely located from the computing device 130. Furthermore, the memory 220 may include one or more storage devices configured to store data (e.g., machine learning data, training data, algorithms, etc.) for use by the programs, as discussed further below.

Computing device 130 may further include one or more input/output (I/O) devices 230. I/O devices 230 may include one or more network adaptors or communication devices and/or interfaces (e.g., WiFi, Bluetooth®, RFID, NFC, RF, infrared, Ethernet, etc.) to communicate with other machines and devices, such as with other components of system 100 through network 110. For example, prompt generator 120 may use a network adaptor to scan for code and code segments within system 100. In some embodiments, the I/O devices 230 may also comprise a touchscreen configured to allow a user to interact with prompt generator 120 and/or an associated computing device. The I/O device 230 may comprise a keyboard, mouse, trackball, touch pad, stylus, and the like.

FIG. 3 is a block diagram of a process 300 for generating a prompt for at least one large language model, in accordance with disclosed embodiments. As depicted in FIG. 3, user 115 may provide an input to prompt generator 120 for updating and transmitting to a large language model 320. The input from user 115 may include for example, a pre-generated query or an open-ended query. In some embodiments, an input from user 115 may include a query to summarize a record (e.g., summarizing an open case or task, summarizing a record history, summarizing the background of a customer, etc.), a query about a feature of a record (e.g., how long has a case been open, when was the record last updated, what is a customer's product history, when does a customer typically respond, etc.), an open-ended question about a record (e.g., providing a suggested solution to a customer problem, provide reasons for using a feature, etc.), or any other question related to a record.

The input from user 115 may be associated with a record. A record may include one or more data fields. A record may refer to, for example, any type of collection, grouping, structure, or organization of data or information. In some examples, a record may include, for example, a row in a database or spreadsheet, multiple rows in one or more databases or spreadsheets linked together, or individual data fields from one or more databases or spreadsheets linked together. Records therefore may contain data from one or more databases or spreadsheets joined under a common record organization scheme. For example, a customer record may contain data fields from a sales database, an invoicing database, a customer service database, and more customer-related data sources all of which may correspond to a single customer record relevant to understanding that customer. For example, the data fields from multiple data sources may be linked together in a data fabric, which may interrelate and link the data fields into defined records. Other examples of records may include a use case record, a claims record, or a support case record. Data record types may then be interrelated and linked to one another, and data fields may be found in one or more different records or different record types. For example, a customer record may be tied to other customers in certain cases, or may be tied to one or more other record types in certain cases, such as claims records or support case records from that customer. These data fields and records drawn from multiple, different sources may be interrelated in complex ways which are not evident from the data sources themselves, for example through different identifiers or terminology referring to common customer records or common data fields (e.g., a customer database indexed by customer ID as compared to a sales database indexed by invoice ID or a support database indexed by support ticket ID) such that it would not be clear to a recipient of the data how the data fields should be understood or linked, inhibiting the ability of a large language model to interpret and understand the data in isolation. Metadata may be available which may assist in understanding the links between data fields, records, or record types.

A data field may refer to, for example, a member, element, portion, section, or part of a record of data. In some examples, one or more computing devices 130 may be configured to store the plurality of records in the one or more databases 140. For example, computing device 130 may facilitate the storage of records in one or more database 140. In some examples, computing device 130 may facilitate different organizations (e.g., companies, firms, governments, universities, or other types of entities) to store their respective data in the one or more databases 140. The computing device 130 may implement or provide a system that may allow an administrator associated with an organization to set or update the configurations for storing the data of the organization in the one or more databases 140. For example, an administrator associated with an organization may use a computing device, such as computing device 130, to set or update the configurations for storing the data of the organization in the one or more databases 140. In some examples, an individual (e.g., an administrator associated with an organization) may define, specify, or configure a record type for the record. Additionally or alternatively, a data type may be configured for each data field of a record, such as a numerical data type, a textual data type, a binary data type, and/or any other data type.

Prompt generator 120 may conduct an access level identification 305 of user 115. Access level identification 305 may be used to determine which records user 115 may have access to based on an access level of user 115. An access level of user 115 may indicate one or more user permission to access a record of the plurality of records stored in database 140 based on a data field of the record. An access level of user 115 may refer to, for example, any type of command, rule, direction, or instruction associated with data security on a record level. For example, the access level of user 115 may indicate whether a particular record is accessible by user 115, and/or conditions for granting access to a particular record. The access level of user 115 may indicate whether user 115 is permitted to access a record based on a data field of the record. For example, a data field of the record may indicate user 115 is associated with the record (e.g., a user 115 assigned to the record), and the indicated user 115 may be permitted to access the record. As another example, the data field of the record may be related to or linked to a data field of another record, and the access permissions to the record may be the same as or based on the access permissions to the other record.

In some embodiments, the access level of user 115 may be based on Role-Based Access Control (“RBAC”). RBAC may control user access to records based on the role (e.g., administrative user, developer, customer, specialist user, end user, third-party user, etc.) of user 115 within an organization. In other embodiments, the access level of user 115 may be hierarchical in nature. For example, user 115 may have access to records based on the hierarchical level (e.g., administrative level, managerial level, developer level, customer level, etc.) of user 115 within an organization. In other embodiments, access controls of records may adhere to security paradigms, such as data minimization or record-level security. In other embodiments, the access level of user 115 may be obtained from a user profile, account settings, security settings, or the like. For example, in a Windows™ environment the access level of user 115 may be accessed from an Active Directory™ profile. Other similar profiles may be used in other operating system environments. In cloud environments, for example, the access level of user 115 may be accessed from a security or access profile such as via Azure Active Directory™, AWS Directory Service™, or various cloud privileged access management services. Various other techniques for referencing user 115's access level are possible as well. For example, security may be enforced on a record level, on a database level, or on a row level.

After identifying an access level of user 115, prompt generator 120 may conduct a record identification 310. Record identification 310 may identify portions of at least one record associated with the input that user 115 may access. The access level of user 115 may indicate that user 115 may access an entire record or a subset of an entire record. Identifying the record associated with the input based on the access level of user 115 may identify data associated with the record and metadata associated with the record that is accessible to user 115. Identifying the portions of a record that are accessible to user 115 based on an access level of user 115 may prevent user 115 from accessing secure data through use of prompt generator 120. Further, identifying portions of a record that are accessible to user 115 based on an access level of user 115 before sending a prompt to a large language model may ensure that the large language model does not have access to secure data.

Prompt generator 120 may then conduct a prompt generation 315. Prompt generator 120 may generate a prompt based on a combination of the input, the data associated with the portion of the record, and the metadata associated with the portion of the record that are accessible to user 115 based on an access level of user 115. As disclosed above, a record may contain data from one or more databases or spreadsheets joined under a common record organization scheme. The record may include a complex data fabric which may connect and link data from one or more databases or spreadsheets. A large language model may not be able to understand the complex relationships found in the record without additional context and background related to the record. Therefore, the prompt may include context related to the record to allow the large language model to understand the prompt and interpret the provided data. For example, the prompt may include instructions that allow the large language model to understand the relationship between the data fields in the record and the relationship between multiple data records. Such instructions may allow the large language model to more accurately and completely answer the question provided by user 115. The prompt may be generated in a natural language format, or in a combination of natural language form and computer-instruction format.

The prompt may then be transmitted to large language model 320. Large language model 320 may correspond to large language model 160, as disclosed herein with respect to FIG. 1. The large language model 320 may generate answer data based on the prompt and the answer data may be transmitted back to user 115.

FIG. 4 depicts a flowchart of a process 400 for generating a prompt for a large language model, in accordance with disclosed embodiments. Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

Step 405 of process 400 may include receiving an input from a user, such as user 115. The input from user 115 may include for example, a pre-generated query or a user-generated query. For example, in some embodiments, an input from user 115 may include a query to summarize a record (e.g., summarizing an open case or task, summarizing a record history, summarizing the background of a customer, etc.), a query about a feature of a record (e.g., how long has a case been open, when was the record last updated, what is a customer's product history, when does a customer typically respond, etc.), a request to generate an output based on the record (e.g., generate an email based on information contained in the record), an open-ended questions about a record (e.g., providing a suggested solution to a customer problem, provide reasons for using a feature, etc.), or any other question related to a record. In some embodiments, an input from user 115 may be received through I/O device 230 of computing device 130.

Step 410 of process 400 may include identifying an access level of the user, such as user 115. Identifying an access level of user 115 may comprise determining which record(s) user 115 may have access to based on an access level of user 115. An access level of user 115 may indicate user permission to access a record in the plurality of records stored in database 140 based on a data field of the record. The access level of user 115 may refer to, for example, any type of command, rule, direction, or instruction associated with data security on a record level. For example, the access level of user 115 may indicate whether a particular record is accessible by a user, and/or conditions for granting access to a particular record. In some embodiments, the access level of user 115 may indicate whether user 115 is permitted to access a record based on a data field of the record. For example, the data field of the record may indicate user 115 is associated with the record (e.g., a user 115 assigned to the record), and the indicated user 115 may be permitted to access the record. As another example, the data field of the record may be related to or linked to a data field of another record, and the access permissions to the record may be the same as or based on the access permissions to the other record.

Step 415 of process 400 may include identifying a portion of a record associated with the input based on the access level of the user. The input received from user 115 may be associated with a particular record or records. The access level of user 115 may define which portions of a particular record or records that user 115 may be able to access. For example, the access level of user 115 may define specific records, rows, data fields, data types, or any other portions of one or more records that may be accessible to user 115. Identifying a portion of a record associated with the input may comprise identifying the specific rows, data fields, data types, or other portions of the record that may be accessible to user 115 based on the identified access level of user 115.

Step 420 of process 400 may include identifying data associated with the portion of the record and step 425 of process 400 may include identifying metadata associated with the portion of the record. Data associated with the portion of the record may comprise data stored in data fields within the portion of the record. The data may be reviewed and analyzed by the large language model to provide answer data in response to the input. Metadata associated with the portion of the record may comprise data providing information about the data within the portion of the record. For example, metadata associated with the portion of the record may comprise a field-level display name (e.g., a name of the field level that may be displayed to an end user), a field-level description (e.g., a description of the data that may be contained in a field), a record type display name (e.g., a name of a record type that may be displayed to an end user), a record type description (e.g., a description of the data that may be contained in a record type) or any other information related to the portion of the record. The metadata may be used to instruct the large language model on how to interpret the complex data relationships found within the data associated with the portion of the record.

Step 430 of process 400 may include generating the prompt based on a combination of the input, the data associated with the portion of the record, and the metadata associated with the portion of the record in a natural language format. The input may comprise a question from a user, such as user 115, which may be related to the record. The data and the metadata associated with the portion of the record may be included in the prompt to allow the large language model to analyze the data and the metadata to generate answer data to the query. The prompt may only include portions of the data and the metadata that user 115 has access to, based on the access level of user 115, so that the large language model does not receive secure data outside the access level of user 115. This may increase the security of the records by preventing user 115 from accessing information outside the access level of user 115 through the large language model. Further, this may increase security of the records by preventing the large language model from accessing secure data. Generating the prompt may comprise converting the input, the data, and the metadata into a format that may be readable and understood by a large language model. For example, in some embodiments, generating the prompt may include converting the input, the data, and the metadata into a natural language format. In some embodiments, the prompt may further comprise instructions for the large language model regarding how to interpret the data and the metadata associated with the record. The data and metadata associated with the record may include complex structures and relationships that may be difficult for a large language model to understand and analyze. For example, the record may interrelate and link multiple data sources into a complex data fabric that a large language model may not be able to understand without the additional context provided in the prompt. Therefore, the prompt may include instructions that may explain the relationships between the data and the metadata of the portion of the record to allow the large language model to accurately analyze the data and the metadata of the portion of the record with an understanding of the relationships and data structures. In some embodiments, the prompt may further include additional instructions, such as instructions to follow organization-specific rules. An organization may have specific rules or preferences for how an output should be generated. For example, organization-specific rules may include instructions that the output should be a specific length (e.g., one sentence, one paragraph, one page, etc.), instructions that the output should be formatted in a bulleted or numbered list, or any other instructions on how an output should be generated or formatted.

Step 435 of process 400 may include providing the prompt to the large language model. The large language model may correspond to large language model 160, as disclosed herein with respect to FIG. 1, or large language model 320, as disclosed herein with respect to FIG. 3. Providing the prompt to the large language model may refer to transmitting or transferring (e.g., across a network, such as network 110) data or information. For example, providing the prompt to the large language model may comprise providing the prompt as input to the large language model. In some embodiments, providing the prompt to the large language model may comprise transmitting the prompt through a proxy to the large language model. The proxy may include credentials that may be used to access the large language model. Transmitting the prompt through a proxy to the large language model may allow for rate limiting (e.g., limiting network traffic to the large language model) if necessary. Further, the proxy may provide authentication to the large language model by containing credentials to access the large language model, signing the request, and forwarding the prompt to the large language model. Accordingly, user 115 may not need to have credentials to access the large language model and may not need to separately provide authentication to the large language model.

The large language model may be able to determine and/or generate answer data based on the prompt, which may direct the large language model to output more accurate and complete answer data compared to a prompt generated without the benefit of the disclosed embodiments. Improved answer data may not only benefit the user by providing accurate and complete answer data, but may also benefit system components, such as by reducing processing and/or memory loads, which may be created by follow-up queries (e.g., further clarifying queries necessitated by machine learning model hallucinations). Process 400 may further include receiving answer data from the large language model and transmitting the answer data to the user. Answer data may comprise information identified by the large language model as responding to the input presented by user 115. The large language model may adjust, enhance, or optimize answer data such that the answer data may be presented in a suitable manner for answering the prompt. Receiving answer data from the large language model may comprise receiving the answer data in a natural language format over a network, such as network 110. For example, the answer data may be transmitted to user 115 over network 110.

In a non-limiting example, a user, such as user 115, may view a customer record through a graphical user interface displayed on computing device 130. A window associated with prompt generator 120 may also be displayed on the graphical user interface. User 115 may enter a question related to the customer record through the window by using I/O device 230. User 115 may enter a question in a natural language format. For example, user 115 may enter the question: “how long has Customer X been a customer?” through the window of the graphical user interface. Without any additional input or prompting by user 115, prompt generator 120 may automatically complete process 400 to generate a prompt related to the user question based on the customer record. Prompt generator 120 may identify an access level of user 115, which may be based on one or more data fields of the customer record, a user profile, account settings, security settings, or the like, as disclosed herein. Prompt generator 120 may then identify a portion of the customer record that may be accessible to user 115 based on the access level of user 115. Prompt generator 120 may identify data and metadata associated with the portion of the customer record so that the generated prompt does not contain any secure data or metadata outside the access level of user 115. Prompt generator 120 may then generate a prompt which may include a combination of the user question (e.g., “how long has Customer X been a customer?”) and the identified data and metadata of the customer record. Prompt generator 120 may then provide the prompt to a large language model, such as large language model 160. Large language model 160 may generate answer data by analyzing the identified data and metadata of the received portion of the customer record. The answer data may be a numeric answer corresponding to the length of time that Customer X has been a customer. Prompt generator 120 may then display the answer data in the window of the graphical user interface of computing device 130.

In some embodiments, process 400 may further include identifying at least one additional record related to the record. Further, these techniques may include identifying, based on the access level of the user, data associated with a portion of the at least one additional record accessible to the user and identifying a relationship between the record and the at least one additional record. In additional embodiments, the techniques may include generating the prompt based on a combination of at least two of: the input, the data associated with the portion of the at least one additional record, the data associated with the portion of the record, the relationship between the record and the at least one additional record, and the metadata associated with the portion of the record.

In some embodiments, the record associated with the input received from user 115 may be related to a plurality of additional records. For example, the record associated with the input may be integrated in a complex data fabric that may connect a plurality of records and data across a plurality of disparate systems. While the input received from user 115 may be related to a particular record, to provide complete and accurate answer data, the large language model may need to receive and analyze a plurality of additional, related records. In some embodiments, a data field of the record associated with the input from user 115 may be associated with or linked to a data field of another record. The data field of the record associated with the input from user 115 and its linked data field in the related record may be a common data field (e.g., the data fields of the two records may have the same data type, may have the same data field type or name, and/or may have the same value). The record related to the input from user 115 and the related record may be of the same record type or may be different record types (e.g., a support case record type, a customer record type, a use case record type, etc.). In some embodiments, the record associated with the input received from user 115 and the additional related records may include a one-to-many relationship (e.g., the record associated with the input received from user 115 may be linked to a plurality of additional records), a many-to-one relationship (e.g., several records may be linked to the record associated with the input received from user 115), a one-to-one relationship (e.g., the record associated with the input received from user 115 may be linked to one other record), or any other relationship.

Process 400 may include identifying at least one additional record related to the record. The record associated with the input from user 115 may include a plurality of identifiers, such as data fields, and the plurality of identifiers may identify a plurality of additional records associated with the record. For example, at least one additional record may be identified by determining that the record associated with the input and the at least one additional record share a common, linked data field (e.g., the data fields of the two records may have the same data type, may have the same data field type or name, and/or may have the same value).

Process 400 may further include identifying, based on the access level of the user, data associated with a portion of the at least one additional record accessible to the user. The access level of the user related to the original record may indicate that the user also has permission to access portions of the at least one additional record based on a common data field. For example, the data field of the record associated with the input may be associated with or linked to a data field of the at least one additional record. The data field of the record associated with the input and the linked data field in the at least one additional record may be a common data field that may indicate the portions of the additional record that the user has permission to view. For example, if the access level of the user allows the user to access a particular data field of the record associated with the input, then it may be determined that the user is permitted to access the at least one additional record associated with or linked to the data field of the record associated with the input. In some embodiments, process 400 may further include identifying metadata associated with at least one additional record accessible to the user based on the access level of the user. In some embodiments, the metadata may comprise a relationship between the record and the at least one additional record. For example, the metadata may be used to instruct the large language model on how to interpret the complex data relationships found within the data associated with the record and the at least one additional record.

Process 400 may further include identifying a relationship between the record and the at least one additional record. The relationship between the record and the at least one additional record may be a one-to-many relationship, a many-to-one relationship, a one-to-one relationship, or any other desired relationship. Further the record and the at least one additional record may be of a same record type or may be of a different record type. Identifying a relationship between the record and the at least one additional record may comprise identifying the linking between the records, for example the linking between data fields of the record and the at least one additional record. The linking of data fields between the record and the at least one additional record may identify the relationship (e.g., one-to-many, many-to-one, one-to-one, etc.) between the record and the at least one additional record.

Process 400 may further include generating the prompt based on a combination of at least two of the input, the data associated with the portion of the at least one additional record, the data associated with the portion of the record, the relationship between the record and the at least one additional record, and metadata associated with the portion of the record. In some embodiments, process 400 may include generating the prompt based on a combination of at least two of the input, the metadata associated with the at least one additional record, the data associated with the portion of the record, and the metadata associated with the portion of the record. The input may comprise a question from a user, such as user 115, which may be related to the record. The data and the metadata associated with the portion of the record and the portion of the additional record may be included in the prompt to allow the large language model to analyze the data and the metadata to generate answer data to the query. The prompt may only include portions of the data and the metadata that the user has access to, based on the access level of the user, so that the large language model does not receive secure data outside the access level of the user. The metadata associated with the portion of the record and the portion of the at least one additional record may include information about the relationship between the record and the at least one additional record. Providing metadata related to the relationship between the record and the at least one additional record may allow the large language model to understand and accurately analyze the complex data relationships so that the large language model may provide complete and accurate answer data in response to the prompt. Generating the prompt may comprise converting the input, the data, and the metadata into a format that may be readable and understood by a large language model. For example, in some embodiments, generating the prompt may include converting the input, the data, and the metadata into a natural language format.

Process 400 may further include receiving, from the large language model, answer data identifying at least one additional record related to the prompt. In such embodiments, process 400 may also include identifying data associated with a portion of the at least one additional record accessible to the user based on the access level of the user. These techniques may further include generating a second prompt, which may include the data associated with the portion of the at least one additional record. The second prompt may be provided to the large language model.

In some embodiments, a user input may include a question related to a record. The record associated with the user input may be related to a plurality of additional records in a complex data fabric relationship. To provide accurate answer data in response to the user input, the large language model may need additional or alternative records related to the record associated with the user input. In such an instance, the answer data received from the large language model may identify at least one additional record related to the prompt that may be needed to accurately answer the user input. The large language model may identify, based on the data and the metadata associated with a portion of the record related to the user input, that the record may be related (e.g., in a many-to-one relationship, one-to-many relationship, one-to-one relationship, or any other relationship) to at least one additional record. The large language model may identify the at least one additional record that may be needed to answer the original user input.

Data associated with a portion of the at least one additional record may be identified based on the access level of the user. The access level of the user in relation to the original record may indicate that the user has permission to access portions of the at least one additional record based on a common data field. For example, the data field of the record associated with the input may be associated with or linked to a data field of the at least one additional record. The data field of the record associated with the input and the linked data field in the at least one additional record may be a common data field that may indicate the portions of the additional record that the user may have permission to view. For example, if the access level of the user allows the user to access a particular data field of the record associated with the input, then it may be determined that the user is permitted to access the at least one additional record associated with or linked to the data field of the record associated with the input.

A second prompt may then be generated. The second prompt may include the data associated with the portion of the at least one additional record. The data associated with the portion of the at least one additional record may allow the large language model to provide complete and accurate answer data based on the data associated with the portion of the original record and the data associated with the portion of the at least one additional record. In some embodiments, the second prompt may further include metadata related to a context or a nature of a relationship between the record and the at least one additional record. A context of a relationship between the record and the at least one additional record may comprise information related to how the record and the at least one additional record may be related. For example, a context of the relationship may comprise information about a linked data field between the record and the at least one additional record. A nature of the relationship between the record and the at least one additional record may comprise information about the type of relationship between the record and the at least one additional record. For example, the nature of the relationship may identify if the record and the at least one additional record have a one-to-many relationship, a many-to-one relationship, a one-to-one relationship, or any other type of relationship. The nature and context of the relationship may provide information to the large language model to allow the large language model to understand and interpret the relationship between the record and the at least one additional record.

The second prompt may then be provided to the large language model. Providing the prompt to the large language model may refer to transmitting or transferring (e.g., across a network) data or information. For example, providing the prompt to the large language model may comprise providing the prompt as input to the large language model.

In a non-limiting example, a user, such as user 115, may view a team record through a graphical user interface displayed on computing device 130. A window associated with prompt generator 120 may also be displayed on the graphical user interface. User 115 may enter a question related to the team record into the window using I/O device 230. For example, user 115 may enter the question “what team is User X on?” through the window. Without any additional input or prompting by user 115, prompt generator 120 may automatically complete process 400 to generate a prompt related to the user question based on the team record. However, after providing the prompt to large language model 160, large language model 160 may determine that at least one additional record is needed to accurately and completely answer the question from user 115. Without any additional input or prompting from user 115, large language model 160 may return answer data to prompt generator 120 that may identify an additional record that may be needed to answer the question from user 115. For example, large language model 160 may identify that a user record is also needed to generate complete answer data. In response to receiving the answer data from large language model 160, prompt generator 120 may automatically identify an access level of user 115 related to the user record. The access level of user 115 for the user record may be related to the access level of user 115 for the team record or may be based on one or more data fields of the user record, a user profile, account settings, security settings, or the like, as disclosed herein. Prompt generator 120 may then identify a portion of the user record that may be accessible to user 115 based on the access level of user 115. Prompt generator 120 may then identify data and metadata of the user record accessible to user 115. By identifying the data and metadata of the user record that is accessible to user 115, prompt generator 120 may prevent large language model 160 from receiving secure or sensitive data or metadata. Prompt generator 120 may then generate a second prompt that may include the data and metadata from the identified portion of the user record and may provide the second prompt to large language model 160. Large language model 160 may generate answer data based on the received prompt and the received second prompt and the answer data may identify the name of the team of User X. Prompt generator 120 may then display the answer data in the window of the graphical user interface of computing device 130.

Process 400 may further include identifying data associated with a portion of at least one additional record related to the record based on the access level of the user and combining the data associated with the portion of the at least one additional record with the input, the data associated with the portion of the record, and the metadata associated with the portion of the record. The data associated with the portion of the at least one additional record may allow the large language model to provide complete and accurate answer data based on the data associated with the portion of the original record and the data associated with the portion of the at least one additional record. The data associated with the portion of the at least one additional record, the input, the data associated with the portion of the record, and the metadata associated with the portion of the record may be combined into a prompt. The prompt may then be provided to a large language model. The data associated with the portion of the record and the data associated with the portion of the at least one additional record may be analyzed by the large language model to provide answer data to the user input. Providing the data associated with the portion of the record and the data associated with the portion of the at least one additional record may allow the large language model to understand the complex relationships between the record and the at least one additional record to provide accurate and complete answer data in response to the user input.

As used herein, unless specifically stated otherwise, being “based on” may include being dependent on, being associated with, being influenced by, or being responsive to. As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Example embodiments are described above with reference to flowchart illustrations or block diagrams of methods, apparatus (systems) and computer program products. It will be understood that each block of the flowchart illustrations or block diagrams, and combinations of blocks in the flowchart illustrations or block diagrams, can be implemented by computer program product or instructions on a computer program product. These computer program instructions may be provided to a processor of a computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer-readable medium that can direct one or more hardware processors of a computer, other programmable data processing apparatus, or other devices to function in a particular manner, such that the instructions stored in the computer-readable medium form an article of manufacture including instructions that implement the function/act specified in the flowchart or block diagram block or blocks.

The computer program instructions may also be loaded onto a computer, other programmable data processing apparatus, or other devices to cause a series of operational steps to be performed (e.g., executed) on the computer, other programmable apparatus or other devices to produce a computer implemented process such that the instructions that execute on the computer or other programmable apparatus provide processes for implementing the functions/acts specified in the flowchart or block diagram block or blocks.

Any combination of one or more computer-readable medium(s) may be utilized. The computer-readable medium may be a non-transitory computer-readable storage medium. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber cable, RF, IR, etc., or any suitable combination of the foregoing.

Computer program code for carrying out operations, for example, embodiments may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The flowchart and block diagrams in the figures illustrate examples of the architecture, functionality, and operation of possible implementations of systems, methods, and computer program products according to various embodiments. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

It is understood that the described embodiments are not mutually exclusive, and elements, components, materials, or steps described in connection with one example embodiment may be combined with, or eliminated from, other embodiments in suitable ways to accomplish desired design objectives.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A non-transitory computer readable medium including instructions that, when executed by at least one processor, cause the at least one processor to perform operations for generating a prompt for a large language model, the operations comprising:
receiving an input from a user;
identifying an access level of the user;
identifying a portion of a record associated with the input based on the access level of the user;
identifying data associated with the portion of the record;
identifying metadata associated with the portion of the record;
generating the prompt based on a combination of the input, the data associated with the portion of the record, and the metadata associated with the portion of the record in a natural language format; and
providing the prompt to the large language model.

2. The non-transitory computer readable medium of claim 1, wherein the operations further comprise:
identifying at least one additional record related to the record;
identifying, based on the access level of the user, data associated with a portion of the at least one additional record accessible to the user;
identifying a relationship between the record and the at least one additional record; and
generating the prompt based on a combination of at least two of: the input, the data associated with the portion of the at least one additional record, the data associated with the portion of the record, the relationship between the record and the at least one additional record, and the metadata associated with the portion of the record.

3. The non-transitory computer-readable medium of claim 1, wherein the record includes a plurality of identifiers, and wherein the plurality of identifiers identify a plurality of additional records.

4. The non-transitory computer-readable medium of claim 3, wherein the operations further comprise identifying metadata associated with at least one additional record from the plurality of additional records accessible to the user based on the access level of the user, wherein the metadata comprises a relationship between the record and the at least one additional record.

5. The non-transitory computer-readable medium of claim 4, wherein the operations further comprise generating the prompt based on a combination of at least two of: the input, the metadata associated with the at least one additional record, the data associated with the portion of the record, and the metadata associated with the portion of the record.

6. The non-transitory computer readable medium of claim 1, wherein the input comprises at least one of: a request to summarize the record, a request about features of the record, or a request to generate an output based on the record.

7. The non-transitory computer readable medium of claim 1, wherein the input comprises at least one of: a pre-generated question or a user-generated question.

8. The non-transitory computer readable medium of claim 1, wherein providing the prompt to the large language model comprises transmitting the prompt through a proxy.

9. The non-transitory computer readable medium of claim 6, wherein the proxy provides authentication to the large language model.

10. The non-transitory computer readable medium of claim 1, wherein the prompt further comprises instructions for the large language model to interpret the record and the metadata.

11. The non-transitory computer readable medium of claim 1, wherein the metadata associated with the record comprises at least one of: a field-level display name, a field-level description, a record type display name, and a record type description.

12. The non-transitory computer readable medium of claim 1, wherein the operations further comprise:
receiving answer data from the large language model; and
transmitting the answer data to the user.

13. A computer-implemented method for generating a prompt for a large language model, the method comprising:
receiving an input from a user;
identifying an access level of the user;
identifying a portion of a record associated with the input based on the access level of the user;
identifying metadata associated with the portion of the record;
identifying data associated with the portion of the record;
generating the prompt based on a combination of the input, the data associated with the portion of the record, and the metadata associated with the portion of the record in a natural language format; and
providing the prompt to the large language model.

14. The method of claim 13, wherein the operations further comprise:
receiving, from the large language model, answer data identifying at least one additional record related to the prompt;
identifying data associated with a portion of the at least one additional record accessible to the user based on the access level of the user;
generating a second prompt, wherein the second prompt includes the data associated with the portion of the at least one additional record; and
providing the second prompt to the large language model.

15. The method of claim 14, wherein the second prompt further comprises metadata related to a context or a nature of a relationship between the record and the at least one additional record.

16. The method of claim 13, wherein the record comprises at least one of: a use case record, a customer record, or a support case record.

17. The method of claim 13, wherein providing the prompt to the large language model comprises transmitting the prompt through a proxy.

18. The method of claim 17, wherein the proxy comprises credentials for the large language model.

19. The method of claim 13, wherein the metadata associated with the record comprises at least one of: a field-level display name, a field-level description, a record type display name, and a record type description.

20. The method of claim 13, wherein the operations further comprise:
identifying data associated with a portion of at least one additional record related to the record based on the access level of the user; and
combining the data associated with the portion of the at least one additional record with the input, the data associated with the portion of the record, and the metadata associated with the portion of the record.
